(19) United States
(12) Patent Application Publication
(10) Pub. No.: US 2013/0215112 A1
(43) Pub. Date: Aug. 22, 2013

(54) Stereoscopic Image Processor, Stereoscopic Image Interaction System, and Stereoscopic Image Displaying Method thereof

(71) Applicant: Etron Technology, Inc., (US)

(72) Inventors: Ming-Che Ho, Kaohsiung City (TW); Ben Wu, Taipei City (TW)

(73) Assignee: ETRON TECHNOLOGY, INC., Hsinchu (TW)

(21) Appl. No.: 13/739,002

(22) Filed: Jan. 11, 2013

(30) Foreign Application Priority Data
Feb. 17, 2012 (TW) 101105263

(51) Int. Cl. G06F 3/01

(52) U.S. Cl. CPC G06F 3/011
USPC 345/420

(57) ABSTRACT

A 3D face model is generated by calculating depths on a left image and a right image. An eye-distance of a user is determined according to the 3D face model. A precise stereoscopic digital image of the user is generated by integrating the 3D face model, the eye-distance, and a user digital image processed by human-body rendering and face morphing. The stereoscopic digital image generated by following the user's appearance can be utilized by the user to serve as an avatar, for enhancing entertainments of the user when the user plays an interactive game using the avatar with other players on the Internet.

### BACKGROUND OF THE INVENTION

1. Field of the Invention

The present invention relates to a stereoscopic image processor, a stereoscopic image interaction system, and a stereoscopic image displaying method thereof, and more particularly, a stereoscopic image processor for displaying a stereoscopic digital image based on a depth map according to a digital image, a stereoscopic image interaction system utilizing the stereoscopic image processor, and a stereoscopic image displaying method thereof.

2. Description of the Prior Art

Because of the popularity of interactive games run via networks, customized avatars were developed for meeting market requirements. For example, the popular gaming device Wii is configured to provide an avatar, where a facial figure, body characteristics, colors, or accessories of the avatar can be set by a player of the avatar; therefore, in some interactive games supported by the gaming device Wii, the avatar can be operated by the player for interacting with other players on the networks.

### SUMMARY OF THE INVENTION

The claimed invention discloses a stereoscopic image displaying method. The image displaying method comprises generating a depth map according to a left image and a right image, where each of the left image and the right image comprises a facial figure and/or a human outline of a user; generating a 3D face model according to the depth map; calculating an eye-distance of the user according to the 3D face model; generating a left-eye rendering/morphing image according to the left image; generating a right-eye rendering/morphing image according to the right image; generating a stereoscopic digital image of the user according to the 3D face model, the eye-distance, the left-eye rendering/morphing image, and the right-eye rendering/morphing image; and displaying the stereoscopic digital image.

The claimed invention discloses a stereoscopic image processor. The stereoscopic image processor comprises a depth unit, a 3D face model generating unit, an eye-distance calculating unit, an image rendering/morphing unit, and a stereoscopic image generating unit. The depth unit is configured to generate a depth map according to a left image and a right image, where each of the left image and the right image comprises a facial figure and/or a human outline of a user. The 3D face model generating unit is configured to generate a 3D face model of the user according to the depth map. The eye-distance calculating unit is configured to calculate an eye-distance of the user according to the 3D face model. The image rendering/morphing unit is configured to generate a left-eye rendering/morphing image according to the left image, and is configured to generate a right-eye rendering/morphing image according to the right image. The stereoscopic image generating unit is configured to generate a stereoscopic digital image of the user according to the 3D face model, the eye-distance, the left-eye rendering/morphing image, and the right-eye rendering/morphing image.

The claimed invention further discloses a stereoscopic image interaction system. The stereoscopic image interaction system comprises a left-eye filming unit, a right-eye filming unit, a stereoscopic image processor and a display. The left-eye filming unit is configured to film a user for generating a left image. The right-eye filming unit is configured to film the user for generating a right image. The stereoscopic image processor comprises a depth unit, a 3D face model generating unit, an eye-distance calculating unit, an image rendering/morphing unit and a stereoscopic image generating unit. The depth unit is configured to generate a depth map according to the left image and the right image, where each of the left image and the right image comprises a facial figure and/or a human outline of a user. The 3D face model generating unit is configured to generate a 3D face model of the user according to the depth map. The eye-distance calculating unit is configured to calculate an eye-distance of the user according to the 3D face model. The image rendering/morphing unit is configured to generate a left-eye rendering/morphing image according to the left image, and is configured to generate a right-eye rendering/morphing image according to the right image. The stereoscopic image generating unit is configured to generate a stereoscopic digital image of the user according to the 3D face model, the eye-distance, the left-eye rendering/morphing image, and the right-eye rendering/morphing image. The display is configured to receive the stereoscopic digital image from the stereoscopic image generating unit and configured to display the stereoscopic digital image.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 illustrates a block diagram of a stereoscopic image processor disclosed according to one embodiment of the present invention.

FIG. 2 illustrates a block diagram of the image rendering/morphing unit shown in FIG. 1 according to one embodiment of the present invention.

FIG. 3 illustrates a block diagram of a stereoscopic image interaction system utilizing the stereoscopic image processor shown in FIG. 1 according to one embodiment of the present invention.

FIG. 4 illustrates a schematic diagram of capturing the left image and the right image using two camera units or camera lenses having a known distance in between corresponding to the embodiments shown in FIG. 1 and FIG. 3.

FIG. 5 illustrates the stereoscopic image displaying method according to one embodiment of the present invention.

### DETAILED DESCRIPTION

The stereoscopic image processor disclosed in the present invention may be utilized for establishing stereo visual characteristics related to a user on an avatar of the user, so that the avatar mimics human body motions and facial expressions of the user. As a result, entertainment and attraction of playing an interactive game can be significantly improved by using the avatar. The stereoscopic image processor disclosed in the present invention is capable of performing depth calculation on facial characteristics of the user to precisely determine a distance between eyes of the user, i.e. an eye-distance, and is further capable of determining a precise stereoscopic image model of the user by integrating information including morphed and rendered images of the user, the eye-distance of the user, and a facial stereoscopic model of the user. Besides, the stereoscopic image displaying method of the present invention is utilized on the stereoscopic image processor of the present invention, and the stereoscopic image interaction system is configured to interact with other users on the networks with the aid of the stereoscopic image processor of the present invention. Therefore, the user may be able to operate an avatar indicated by a digital image generated from a stereoscopic image model of the user for enhancing entertainment of interacting with other users via networks, where the stereoscopic image model mimics human body motions and facial expressions of the user.

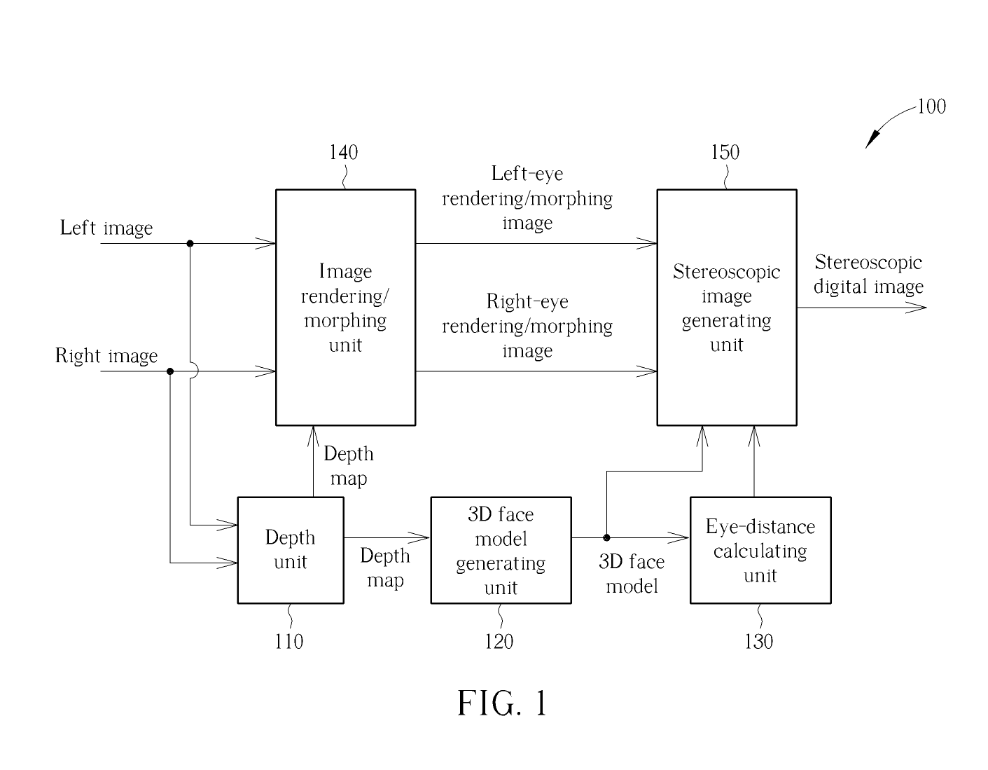

Please refer to FIG. 1, which illustrates a block diagram of a stereoscopic image processor 100 disclosed according to one embodiment of the present invention. As shown in FIG. 1, the stereoscopic image processor 100 includes a depth unit 110, a 3D face model generating unit 120, an eye-distance calculating unit 130, an image rendering/morphing unit 140, and a stereoscopic image generating unit 150. Before the stereoscopic image processor 100 is operated, a left image and a right image are received. The left image and the right image are captured by filming a user using two external neighboring camera lenses so that both the left image and the right image comprise a facial image and/or an outline image of the user, where a distance between the two neighboring camera lenses are known. Besides, the left image and the right image may be generated using a three-dimensional camera.

The depth unit 110 is configured to generate a depth map according to the left image and the right image, where the depth map is utilized for indicating depths of pixels in the left image and the right image.

The 3D face model generating unit 120 is configured to estimate depths on the facial image of the user according to the depth map for generating a 3D face model of the user. The procedure of generating the 3D face model includes a first procedure of detecting a face pattern of the user on each of the left image and the right image and a second procedure of fetching depths from the depth map corresponding to face location of the user.

The eye-distance calculating unit 130 is configured to locate a left-eye location and a right-eye location of the user on each of the left image and the right image according to the 3D face model, and is configured to calculate an eye-distance of the user according to a distance between the left-eye location and the right-eye location. A phenomenon that a left eye and a right eye of a human being have higher depths than respective surroundings is followed for locating the left-eye location and the right-eye location, so that locations of the left eye and the right eye on the 3D face model can be determined.

The 3D face model and the eye-distance are critical factors in precisely generating the stereoscopic digital image for rendering the stereoscopic digital image to highly release the user's experience.

The image rendering/morphing unit 140 is configured to perform face morphing and human-body rendering on the left image and the right image, and may be capable of performing the face morphing and the human-body rendering with a higher precision by referencing the depth map generated by the depth unit 110 according to one embodiment of the present invention. The human-body morphing includes establishing colors on a stereoscopic digital skeleton image via software according to a user outline image captured on the left image and the right image. The face morphing includes performing strengthening certain characteristics or changing sizes of said certain characteristics on a user face image captured on the left image and the right image to generate a stereoscopic digital image giving a closer sense of stereo or having facial characteristics that the user wants. After performing the face morphing and the human-body rendering, the image rendering/morphing unit 140 is configured to generate a left-eye rendering/morphing image and a right-eye rendering/morphing image. In one embodiment of the present invention, the face morphing includes cartoon emotions and facial expressions mimics, or exaggerated facial expressions.

At last, the stereoscopic image generating unit 150 is configured to strengthen the sense of stereo on a face pattern captured on the left-eye rendering/morphing image and the right-eye rendering/morphing image according to the abovementioned 3D face model and the abovementioned eye-distance to generate a stereoscopic digital image of the user. In some embodiments of the present invention, a format of the stereoscopic digital image may be Red-Cyan anaglygh, side-by-side, or interlaced.

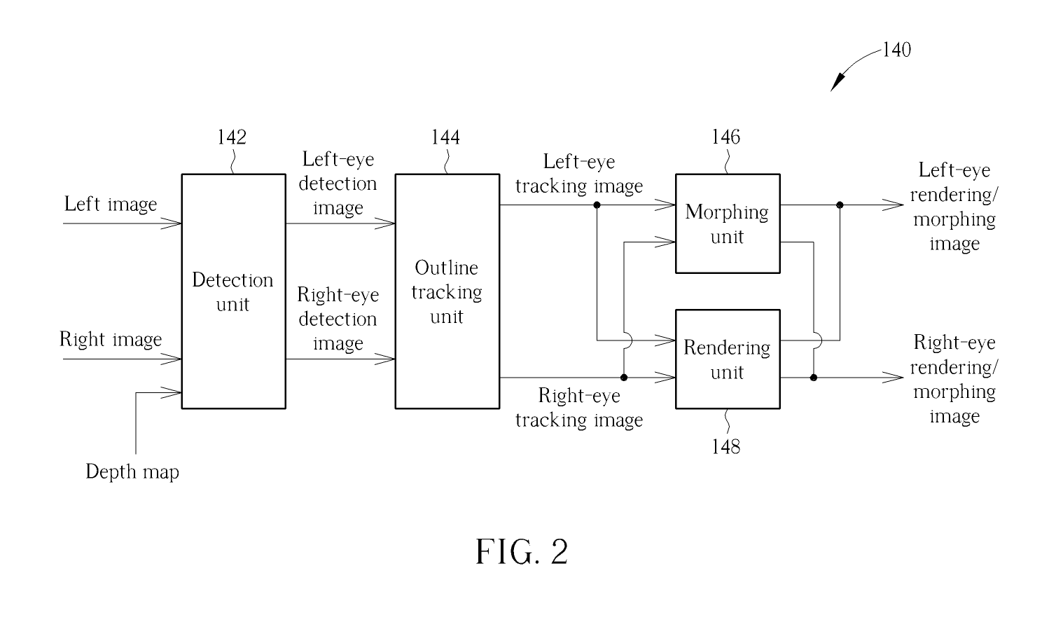

Please refer to FIG. 2, which illustrates a block diagram of the image rendering/morphing unit 140 shown in FIG. 1 according to one embodiment of the present invention. As shown in FIG. 2, the image rendering/morphing unit 140 includes a detection unit 142, an outline tracking unit 144, a morphing unit 146, and a rendering unit 148. The detection unit 142 is configured to perform human-body detection and facial detection on the left image to generate a left-eye detection image and on the right image to generate a right-eye detection image. The detection unit 142 is further configured to perform more precise human-body detection and face detection with the aid of the depth map generated by the depth unit 110. The outline tracking unit 144 is configured to perform human-body outline tracking and face outline tracking on the left-eye detection image to generate a left-eye tracking image and on the right-eye detection image to generate a right-eye tracking image. The morphing unit 146 is configured to perform face morphing on the left-eye tracking image and the right-eye tracking image, the rendering unit 148 is configured to perform human-body rendering on the left-eye tracking image and the right-eye tracking image, and as a result, the left-eye rendering/morphing image and the right-eye rendering/morphing image are generated with the aid of the morphing unit 146 and the rendering unit 148.

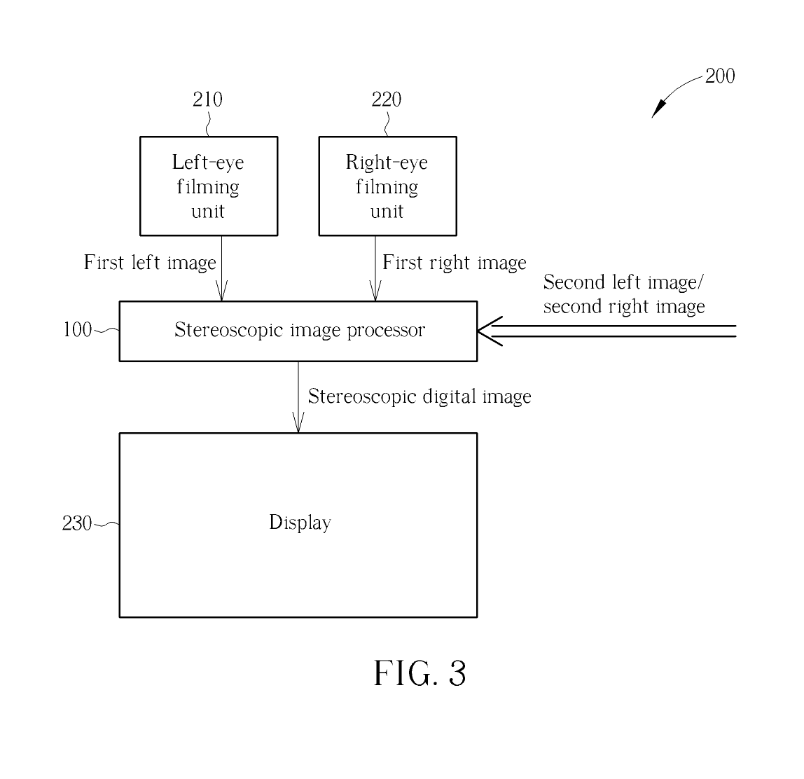

Please refer to FIG. 3, which illustrates a block diagram of a stereoscopic image interaction system 200 utilizing the stereoscopic image processor 100 shown in FIG. 1 according to one embodiment of the present invention. As shown in FIG. 3, the stereoscopic image interaction system 200 includes a left-eye filming unit 210, a right-eye filming unit 220, the stereoscopic processor 100, and a display 230.

The left-eye filming unit 210 is configured to generate a first left image, i.e. the left image shown in FIG. 1. The right-eye filming unit 220 is configured to generate a first right image, i.e. the right image shown in FIG. 1. The left-eye filming unit 210 and the right-eye filming unit 220 have a known distance in between, similar as both the external neighboring camera lenses mentioned above. In one embodiment of the present invention, the left-eye filming unit 210 and the right-eye filming unit 220 are two camera lenses of a three-dimensional camera.

The stereoscopic image interaction system 200 is capable of connecting with other stereoscopic image interaction systems of other users via networks, where the other stereoscopic image interaction systems share the same elements and functions as the stereoscopic image interaction system 200. That is, the other stereoscopic image interaction systems are capable of filming left images and right images of the other users and transmitting the filmed left images and right images to the stereoscopic image interaction system 200 for the purpose of interaction. The second left image and the second right image are transmitted from other stereoscopic image systems via the networks, and are transmitted to the image rendering/morphing unit 140 of the stereoscopic image processor 100 so that the first left image, the first right image, the second left image, and the second right image are together performed with the human-body rendering and the facial morphing with the aid of the stereoscopic image processor 100. The stereoscopic image processor 100 is configured to generate a stereoscopic digital image corresponding to a user of the stereoscopic image interaction system 200 according to the first left image and the first right image, and another user of another stereoscopic image interaction system according to the second left image and the second right image.

The display 230 is configured to receive the stereoscopic digital image, and is capable of displaying the stereoscopic digital image. Since the stereoscopic digital image mimics human body motion and facial expressions of both the user of the stereoscopic image interaction system 200 and another user of another stereoscopic image interaction system, avatars corresponding to the two users may interact with each other for providing entertainment. But, the avatars in the stereoscopic digital image in the present invention are not limited to corresponding to two users. In another embodiment of the present invention, the avatars in the stereoscopic digital image may correspond to more than two users.

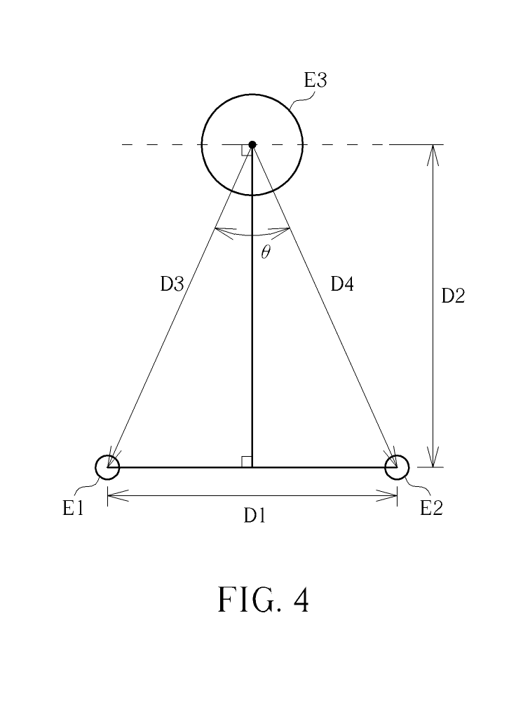

In FIG. 1 and FIG. 3, it has been mentioned that a known distance is required between the camera lenses capturing the left image and the right image. Please refer to FIG. 4, which illustrates a schematic diagram of capturing the left image and the right image using two camera units or camera lenses having a known distance in between corresponding to the embodiments shown in FIG. 1 and FIG. 3. As shown in FIG. 4, a location E1 indicates a location of the left-eye filming unit 210, a location E2 indicates a location of the right-eye filming unit 220, and a distance D1 between the location E1 and the location E2 is known. While using the left-eye filming unit 210 and the right-eye filming unit 220 for capturing images for an object located at a location E3, e.g. a face of a user, a direction from the object to the location E1 is a direction D3, and a direction from the object to the location E2 is a direction D4. An angle θ between the direction D3 and the direction D4 may be determined according to the left image and the right image. Under the condition that the distance D1 is known, a real image depth D2 may be precisely determined according to the angle θ and the distance D1. Thus, precision of the 3D face model and the eye-distance may be significantly improved.

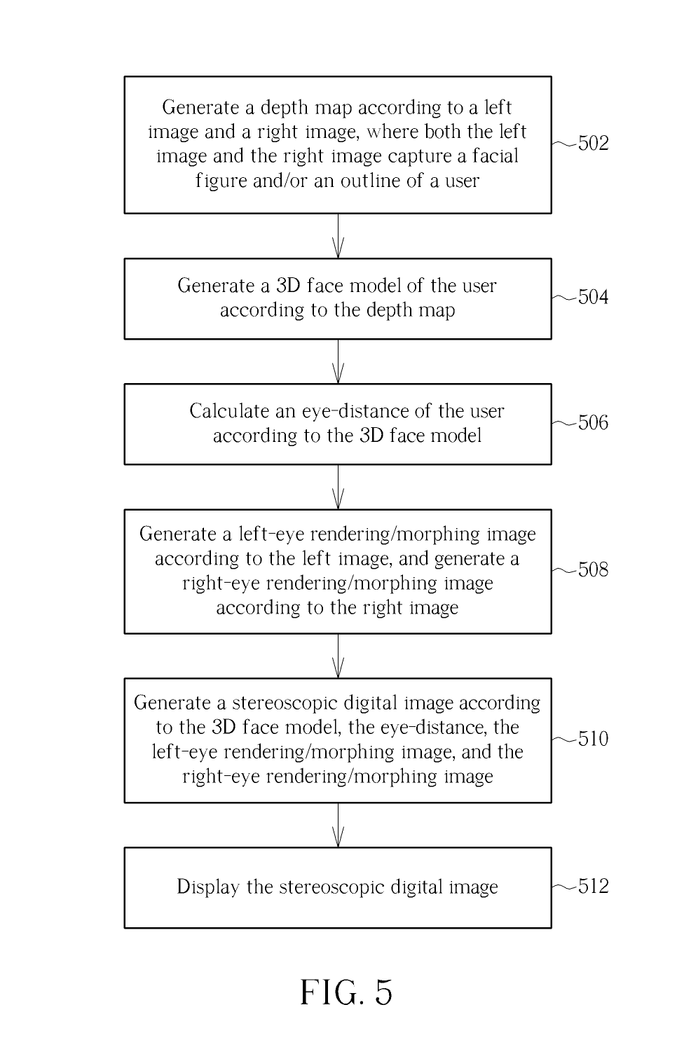

Please refer to FIG. 5, which illustrates the stereoscopic image displaying method of the present invention according to one embodiment of the present invention. As shown in FIG. 5, the stereoscopic image displaying method includes steps as follows:

Step 502: Generate a depth map according to a left image and a right image, where both the left image and the right image capture a facial figure and/or an outline of a user;

Step 504: Generate a 3D face model of the user according to the depth map;

Step 506: Calculate an eye-distance of the user according to the 3D face model;

Step 508: Generate a left-eye rendering/morphing image according to the left image, and generate a right-eye rendering/morphing image according to the right image;

Step 510: Generate a stereoscopic digital image according to the 3D face model, the eye-distance, the left-eye rendering/morphing image, and the right-eye rendering/morphing image;

Step 512: Display the stereoscopic digital image.

Contents of Step 502, Step 504, Step 506, Step 508 and Step 510 are primarily implemented by the stereoscopic image processor 100 shown in FIG. 1, and contents of Step 512 are primarily implemented by the display 230 shown in FIG. 3.

It is noted that embodiments formed by reasonable combinations/permutations of and/or by adding the abovementioned limitations to the steps shown in FIG. 5 should also be regarded as embodiments of the present invention.

The stereoscopic image processor, the stereoscopic image interaction system, and the stereoscopic image displaying method are utilized for enhancing precision in measuring facial characteristics of a user to generate an avatar highly resembling with the user in vision, and entertainment is introduced as a result. Besides, during the procedure of generating the stereoscopic digital image in some embodiments of the present invention, the eye-distance of the user is utilized for adjusting the stereoscopic digital image so that the user is able to have a great sense of stereo while watching the stereoscopic digital image.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A stereoscopic image displaying method, comprising:
generating a depth map according to a left image and a right image, wherein each of the left image and the right image comprises a facial figure and/or a human outline of a user;
generating a 3D face model according to the depth map;
calculating an eye-distance of the user according to the 3D face model;
generating a left-eye rendering/morphing image according to the left image;
generating a right-eye rendering/morphing image according to the right image;
generating a stereoscopic digital image of the user according to the 3D face model, the eye-distance, the left-eye rendering/morphing image, and the right-eye rendering/morphing image; and
displaying the stereoscopic digital image.

2. The method of claim 1 wherein generating the left-eye rendering/morphing image according to the left image comprises:
performing human-outline detection and/or facial detection on the left image for generating a left-eye detection image;
performing human-outline tracking and/or facial outline tracking on the left-eye detection image for generating a left-eye tracking image; and
performing facial morphing and human-outline rendering on the left-eye tracking image for generating the left-eye rendering/morphing image; and
wherein generating the right-eye rendering/morphing image according to the right image comprises:
performing human-outline detection and/or facial detection on the right image for generating a right-eye detection image;
performing human-outline tracking and/or facial outline tracking on the right-eye detection image for generating a right-eye tracking image; and
performing facial morphing and human-outline rendering on the right-eye tracking image for generating the right-eye rendering/morphing image.

3. The method of claim 1 wherein calculating the eye-distance of the user according to the depth map comprises:
detecting a left-eye location and a right-eye location on both the left image and the right image according to the 3D face model; and
calculating a distance between the left-eye location and the right-eye location to generate the eye-distance.

4. The method of claim 1 wherein a format of the stereoscopic digital image is Red-Cyan anaglyph, side-by-side, or interlaced.

5. The method of claim 1 wherein the left image and the right image are captured using a three-dimensional camera.

6. A stereoscopic image processor, comprising:
a depth unit, configured to generate a depth map according to a left image and a right image, wherein each of the left image and the right image comprises a facial figure and/or a human outline of a user;
a 3D face model generating unit, configured to generate a 3D face model of the user according to the depth map;
an eye-distance calculating unit, configured to calculate an eye-distance of the user according to the 3D face model;
a image rendering/morphing unit, configured to generate a left-eye rendering/morphing image according to the left image, and configured to generate a right-eye rendering/morphing image according to the right image; and
a stereoscopic image generating unit, configured to generate a stereoscopic digital image of the user according to the 3D face model, the eye-distance, the left-eye rendering/morphing image, and the right-eye rendering/morphing image.

7. The stereoscopic image processor of claim 6, wherein the image rendering/morphing unit comprises:
a detection unit, configured to perform human-outline detection and/or facial detection on the left image for generating a left-eye detection image, and configured to perform human-outline detection and/or facial detection on the right image for generating a right-eye detection image;
an outline tracking unit, configured to perform human-outline tracking and/or facial outline tracking on the left-eye detection image for generating a left-eye tracking image, and configured to perform human-outline tracking and/or facial outline tracking on the right-eye detection image for generating a right-eye tracking image; and
a morphing unit and a rendering unit, wherein the morphing unit is configured to perform facial morphing on the left-eye tracking image and the right-eye tracking image, and the rendering unit is configured to perform human-outline rendering on the left-eye tracking image and the right-eye tracking image, for generating the left-eye rendering/morphing image and the right-eye rendering/morphing image.

8. The stereoscopic image processor of claim 6, wherein the eye-distance calculating unit is configured to detect a left-eye location and a right-eye location on both the left image and the right image according to the 3D face model, and configured to calculate the eye-distance of the user according to the left-eye location and the right-eye location.

9. The stereoscopic image processor of claim 6, wherein a format of the stereoscopic digital image is Red-Cyan anaglyph, side-by-side, or interlaced.

10. The stereoscopic image processor of claim 6, wherein the left image and the right image are captured using a three-dimensional camera.

11. A stereoscopic image interaction system, comprising:
a left-eye filming unit, configured to film a user for generating a left image;
a right-eye filming unit, configured to film the user for generating a right image;
a stereoscopic image processor, comprising:
a depth unit, configured to generate a depth map according to the left image and the right image, wherein each of the left image and the right image comprises a facial figure and/or a human outline of a user;
a 3D face model generating unit, configured to generate a 3D face model of the user according to the depth map;
an eye-distance calculating unit, configured to calculate an eye-distance of the user according to the 3D face model;
a image rendering/morphing unit, configured to generate a left-eye rendering/morphing image according to the left image, and configured to generate a right-eye rendering/morphing image according to the right image; and
a stereoscopic image generating unit, configured to generate a stereoscopic digital image of the user according to the 3D face model, the eye-distance, the left-eye rendering/morphing image, and the right-eye rendering/morphing image; and
a display, configured to receive the stereoscopic digital image from the stereoscopic image generating unit and configured to display the stereoscopic digital image.

12. The stereoscopic image interaction system of claim 11, wherein the image rendering/morphing unit comprises:
a detection unit, configured to perform human-outline detection and/or facial detection on the left image for generating a left-eye detection image, and configured to perform human-outline detection and/or facial detection on the right image for generating a right-eye detection image;
an outline tracking unit, configured to perform human-outline tracking and/or facial outline tracking on the left-eye detection image for generating a left-eye tracking image, and configured to perform human-outline tracking and/or facial outline tracking on the right-eye detection image for generating a right-eye tracking image; and
a morphing unit and a rendering unit, wherein the morphing unit is configured to perform facial morphing on the left-eye tracking image and the right-eye tracking image, and the rendering unit is configured to perform human-outline rendering on the left-eye tracking image and the right-eye tracking image, for generating the left-eye rendering/morphing image and the right-eye rendering/morphing image.

13. The stereoscopic image interaction system of claim 11, wherein the eye-distance calculating unit is configured to detect a left-eye location and a right-eye location on both the left image and the right image according to the 3D face model, and configured to calculate the eye-distance of the user according to the left-eye location and the right-eye location.

14. The stereoscopic image interaction system of claim 11, wherein a format of the stereoscopic digital image is Red-Cyan anaglyph, side-by-side, or interlaced.

15. The stereoscopic image interaction system of claim 11, wherein the left image and the right image are captured using a three-dimensional camera.
